(19) United States
(12) Patent Application Publication
(10) Pub. No.: US 2013/0217285 A1
(43) Pub. Date: Aug. 22, 2013

(54) Hydrophobic Substrates And Methods For Their Production Using Acyloxysilanes

(71) Applicants: Kevin Dale Lewis, Sanford, MI (US); William James Schulz, JR., Midland, MI (US)

(72) Inventors: Kevin Dale Lewis, Sanford, MI (US); William James Schulz, JR., Midland, MI (US)

(73) Assignee: Dow Corning Corporation, Midland, MI (US)

(21) Appl. No.: 13/877,776

(22) PCT Filed: May 16, 2011
(86) PCT No.: PCT/US11/36583

§ 371 Date: Apr. 4, 2013

Related U.S. Application Data
(60) Provisional application No. 61/390,631, filed on Oct. 7, 2010.

(51) Int. Cl. C09D 5/00; B05D 3/10; B05D 1/30; B05D 1/02; B05D 1/18; B05D 1/00; B05D 1/26

(52) U.S. Cl. CPC C09D 5/00; B05D 1/60; B05D 3/107; B05D 1/26; B05D 1/02; B05D 1/18; B05D 1/30
USPC 442/81; 428/447; 427/255.6; 427/337; 427/420; 427/421.1; 427/430.1

(57) ABSTRACT

A method for rendering a substrate hydrophobic includes treating the substrate with an acyloxysilane. The treatment includes impregnating the substrate with an acyloxysilane and thereafter curing (hydrolyzing and condensing the acyloxysilane) to form a silicone resin. The method is particularly useful for rendering paper hydrophobic.

### CROSS REFERENCE TO RELATED APPLICATIONS

None.

### TECHNICAL FIELD

Hydrophobic substrates and methods for rendering the substrates hydrophobic are disclosed. More specifically, the method includes rendering cellulosic substrates hydrophobic with an acyloxysilane. Certain substrates may be both hydrophobic and biodegradable.

### BACKGROUND

Cellulosic substrates such as paper and cardboard (such as corrugated fiberboard, paperboard, display board, or card stock) products encounter various environmental conditions based on their intended use. For example, cardboard is often used as packaging material for shipping and/or storing products and must provide a durable enclosure that protects its contents. Some such environmental conditions cellulosic substrates may face are water through rain, temperature variations which may promote condensation, flooding, snow, ice, frost, hail or any other form of moisture. Other products include disposable food service articles, which are commonly made from paper or paperboard. These cellulosic substrates also face moist environmental conditions, e.g., vapors and liquids from the foods and beverages they come in contact with. Water in its various forms may threaten a cellulosic substrate by degrading its chemical structure through hydrolysis and cleavage of the cellulose chains and/or breaking down its physical structure via irreversibly interfering with the hydrogen bonding between the chains, thus decreasing its performance in its intended use. When exposed to water, other aqueous fluids, or significant amounts of water vapor, items such as paper and cardboard may become soft, losing form-stability and becoming susceptible to puncture (e.g., during shipping of packaging materials or by cutlery such as knives and forks used on disposable food service articles).

Manufacturers may address the problem of the moisture-susceptibility of disposable food service articles by not using the disposable food service articles in moist environments. This approach avoids the problem simply by marketing their disposable food service articles for uses in which aqueous fluids or vapor are not present (e.g., dry or deep-fried items). However, this approach greatly limits the potential markets for these articles, since many food products (1) are aqueous (e.g., beverages, soups), (2) include an aqueous phase (e.g., thin sauces, vegetables heated in water), or (3) give off water vapor as they cool (e.g., rice and other starchy foods, hot sandwiches, etc.).

Another way of preserving cellulosic substrates is to prevent the interaction of water with the cellulosic substrate. For example, films or coatings (e.g., polymeric water-proofing materials such as wax or polyethylene) may be applied to the surface of the cellulosic substrates to prevent water from contacting the cellulosic substrate directly. This approach essentially forms a laminated structure in which a water-sensitive core is sandwiched between layers of a water-resistant material. Many coatings, however, are costly to obtain and difficult to apply, thus increasing manufacturing cost and complexity and reducing the percentage of acceptable finished products. Furthermore, films and coatings can degrade or become mechanically compromised and become less effective over time. Films, coatings and other such “surface only” treatments also have the inherent weakness of poorly treated substrate edges. Even if the edges can be treated to impart hydrophobicity to the entire substrate, any rips, tears, wrinkles, or folds in the treated paper can result in the exposure of non-treated surfaces that are easily wetted and can allow wicking of water into the bulk of the cellulosic substrate. Furthermore, certain films, coatings, and other known hydrophobing treatments for cellulosic substrates may also render the substrates not biodegradable.

Another option is to treat the cellulosic substrate with a chlorosilane. However, the use of chlorosilanes generates HCl from the reaction of the moisture and chlorosilane, and this process suffers from the drawback that HCl, and other strong acids, can promote the chain scission of the cellulose polymers that make-up the fibers within the cellulosic substrates. As a result, these substrates can be weakened or degraded when excessive amounts of the HCl are formed or cannot be removed. Furthermore, a base may be needed to neutralize the resultant byproduct acid from the reaction of the chlorosilane with water. Not only is it undesirable to have this additional step in the treatment process, but neutralization of HCl also leaves an undesirable by-product salt in the treated paper.

An alternative system for rendering cellulosic substrates hydrophobic involves their exposure to solutions of alkoxysilanes in polar solvents. However, this process may suffer from the drawback that the cure time of the treatment to render the substrate hydrophobic may be too long for commercial feasibility. In addition, alcohol byproducts are formed by the reaction of the alkoxysilanes and water, creating concerns around the flammability of the alcohol byproducts. For methanol in particular, there are issues with toxicity. Systems based on ethoxysilanes could reduce toxicity concerns, but the kinetics of curing the resin will be reduced significantly for ethoxysilanes relative to methoxysilane-based systems.

### SUMMARY

A method includes treating a substrate with an acyloxysilane and/or a prepolymer thereof. The substrate has a relatively low surface area/volume ratio.

### DETAILED DESCRIPTION

All amounts, ratios, and percentages described herein are by weight unless otherwise indicated. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group a hydrogen atom, an alkyl group, an aryl group, an aralkyl group, or an alkaryl group includes the member alkyl individually; the subgroup alkyl and aryl; and any other individual member and subgroup subsumed therein.

Substrates can be rendered hydrophobic by treating the substrates with an acyloxysilane. The acyloxysilane can be applied in any manner such that the acyloxysilane penetrates the substrate and produces a silicone resin such that the volume (as well as the surface) of the substrate is rendered hydrophobic. In addition, by varying the amounts and type of the acyloxysilane, the physical properties of the substrate may be altered. All or a portion of the volume may be rendered hydrophobic. Alternatively, the entire volume of the substrate may be rendered hydrophobic. For example, when a relatively thin substrate, such as cardboard, boxboard, or other paper substrate is treated, the entire volume may be rendered hydrophobic. When a thicker substrate, such as a masonry brick or other building material is treated, the surface and a portion of the volume near the surface may be rendered hydrophobic.

### Substrates

For use in the method described herein, suitable substrates have a thickness and a relatively low surface area to volume ratio, i.e., relatively low means that the surface area to volume ratio is lower than that of a particulate material. Suitable substrates are exemplified by, but not limited to building materials; cellulosic substrates such as wood and/or wood products (e.g., boards, plywood, planking for fences and/or decks, telephone poles, railroad ties, or fiberboard), paper (such as cardboard, boxboard, wallboard, paper used to coat insulation or liners used to make corrugated cardboard), or textiles; insulation; drywall (such as sheet rock); masonry brick; or gypsum. For purposes of this application, the term ‘substrate’ excludes minerals or fillers in powder form.

The thickness of the substrate depends on various factors including the type of substrate selected. The thickness of the substrate can be uniform or vary, and the substrate can comprise one continuous piece of material or comprise a material with openings such as pores, apertures, and/or holes disposed therein. Furthermore, the substrate may comprise a single, flat, substrate (such as a single flat piece of paper or wallboard) or may comprise a folded, assembled or otherwise manufactured substrate. For example, the substrate can comprise multiple substrates glued, rolled or woven together (such as a box) or can comprise varying geometries (such as a masonry brick). In addition, the substrate can be a subset component of a larger substrate such as when the substrate is combined with plastics, fabrics, non-woven materials and/or glass. It should be appreciated that substrates may thereby embody a variety of different materials, shapes and configurations and should not be limited to the exemplary embodiments expressly listed herein.

Alternatively, the substrates useful in the method described herein may be biodegradable. For purposes of this application, the terms ‘compostable,’ and ‘compostability’ encompass factors such as biodegradability, disintegration, and ecotoxicity. The terms ‘biodegradable,’ ‘biodegradability,’ and variants thereof refer to the nature of the material to be broken down by microorganisms. Biodegradable means a substrate breaks down through the action of a microorganism, such as a bacterium, fungus, enzyme, and/or virus over a period of time. The term ‘disintegration,’ ‘disintegrate,’ and variants thereof refer to the extent to which the material breaks down and falls apart. Ecotoxicity testing determines whether the material after composting shows any inhibition on plant growth or the survival of soil or other fauna. Biodegradability and compostability may be measured by visually inspecting a substrate that has been exposed to a biological inoculum (such as a bacterium, fungus, enzyme, and/or virus) to monitor for degradation. Alternatively, the biodegradable substrate passes ASTM Standard D6400; and alternatively the biodegradable substrate passes ASTM Standard D6868-03. In general, rate of compostability and/or biodegradability may be increased by maximizing surface area to volume ratio of each substrate. For example, surface area/volume ratio may be at least 10, alternatively at least 17. Alternatively, surface area/volume ratio may be at least 33. Without wishing to be bound by theory, it is thought that a surface area/volume ratio of at least 33 will allow the substrate to pass the test for biodegradability in ASTM Standard D6868-03. For purposes of this application, the terms ‘hydrophobic’ and ‘hydrophobicity,’ and variants thereof, refer to the water resistance of a substrate. Hydrophobicity may be measured according to the Cobb test set forth in Reference Example 1, below. The substrates treated by the method described herein may also be inherently recyclable. The substrates may also be repulpable, e.g., the hydrophobic substrate prepared by the method described herein may be reduced to pulp for use in making paper. The substrates may also be repurposeable.

The method described herein is particularly useful for rendering cellulosic substrates hydrophobic. Cellulosic substrates are substrates that substantially comprise the polymeric organic compound cellulose having the formula (C₆H₁₀O₅)ₙ where n is any integer. Cellulosic substrates possess —OH functionality and contain water, and optionally other ingredients that may react with the acyloxysilane, such as lignin. Lignin is a polymer that results from the copolymerization of a mixture of monolignols such as p-coumaryl alcohol, coniferyl alcohol, and/or sinapyl alcohol. This polymer has residual —OH functionality with which the acyloxysilane can react. Depending on the intended application for the cellulosic substrate and the manufacturing process thereof, the cellulosic substrate can comprise sizing agents and/or additional additives or agents to alter its physical properties or assist in the manufacturing process. Exemplary sizing agents include starch, rosin, alkyl ketene dimer, alkenyl succinic acid anhydride, alkylated melamine, styrene acrylate copolymer, styrene maleic anhydride, glue, gelatin, modified celluloses, synthetic resins, latexes and waxes. Other exemplary additives and agents include bleaching additives (such as chlorine dioxide, oxygen, ozone and hydrogen peroxide), wet strength agents, dry strength agents, fluorescent whitening agents, calcium carbonate, optical brightening agents, antimicrobial agents, dyes, retention aids (such as anionic polyacrylamide and polydiallydimethylammonium chloride), drainage aids (such as high molecular weight cationic acrylamide copolymers, bentonite and colloidal silicas), biocides, fungicides, slimacides, talc and clay and other substrate modifiers such as organic amines including triethylamine and benzylamine. It should be appreciated that other sizing agents and additional additives or agents not listed explicitly herein may alternatively be applied, alone or in combination. For example, where the cellulosic substrate comprises paper, the paper can also comprise or have undergone bleaching to whiten the paper, starching or other sizing operation to stiffen the paper, clay coating to provide a printable surface, or other alternative treatments to modify or adjust its properties. Furthermore, cellulosic substrates such as paper can comprise virgin fibers, wherein the paper is created for the first time from non-recycled cellulose compounds, recycled fibers, wherein the paper is created from previously used cellulosic materials, or combinations thereof.

When a cellulosic substrate is used, the cellulosic substrate may vary in thickness and/or weight depending on the type and dimensions of the substrate. The thickness of the cellulosic substrate can range from less than 1 mil (where 1 mil=0.001 inches=0.0254 millimeters (mm)) to greater than 150 mils (3.81 mm), from 10 mils (0.254 mm) to 60 mils (1.52 mm), from 20 mils (0.508 mm) to 45 mils (1.143 mm), from 30 mils (0.762 mm) to 45 mils (1.143 mm) or have any other thickness that allows it to be penetrated by the acyloxysilane as will become appreciated herein. The thickness of the cellulosic substrate can be uniform or vary and the cellulosic substrate can comprise one continuous piece of material or comprise a material with openings such as pores, apertures, or holes disposed therein. Furthermore, the cellulosic substrate may comprise a single flat cellulosic substrate (such as a single flat piece of paper) or may comprise a folded, assembled or otherwise manufactured cellulosic substrate (such as a box, bag, or envelope). For example, the cellulosic substrate can comprise multiple substrates glued, rolled or woven together or can comprise varying geometries such as corrugated cardboard. In addition, the cellulosic substrates can comprise a subset component of a larger substrate such as when the cellulosic substrate is combined with plastics, fabrics, non-woven materials and/or glass. It should be appreciated that cellulosic substrates may thereby embody a variety of different materials, shapes and configurations and should not be limited to the exemplary embodiments expressly listed herein.

The dimensions of the substrate depend on various factors including the strength of the wetted substrate and the method used for treating the substrate. However, the substrate may have a minimum thickness of 2 mils Alternatively, the substrate may be a three-dimensional object where the thickness is at least 2 mils and the length and width are each at least 2 inches.

The substrate can be treated in an environment with a controlled temperature. The temperature depends on various factors including the type of substrate selected and the desired cure time to form the silicone resin. However, for example, the substrate can be treated in a chamber, where the temperature inside the chamber may range from −40° C. to 400° C., alternatively −40° C. to 200° C., alternatively 10° C. to 80° C., or alternatively 22° C. to 25° C. When the substrate comprises paper, the temperature may range from 25° C. to 95° C., alternatively 10° C. to 80° C., or alternatively 22° C. to 25° C. The temperature may vary during different method steps, for example, the chamber may be kept at a lower temperature when the acyloxysilane penetrates the thickness of the substrate, and temperature may be raised when forming the resin.

### Acyloxysilane

In the method described herein, the cellulosic substrate is penetrated by an acyloxysilane. For purposes of this application, the term acyloxysilane means a silane having at least one acyloxy group bonded to silicon. Within the scope of this disclosure, silanes are defined as silicon-based monomers or oligomers that contain functionality that can react with water in a substrate, with —OH groups on the cellulosic substrates and/or sizing agents or additional additives applied to the cellulosic substrates as appreciated herein. Acyloxysilanes with a single acyloxy group directly bonded to silicon are defined as monoacyloxysilanes, acyloxysilanes with two acyloxy groups directly bonded to silicon are defined as diacyloxysilanes, acyloxysilanes with three acyloxy groups directly bonded to silicon are defined as triacyloxysilanes and acyloxysilanes with four acyloxy groups directly bonded to silicon are defined as tetraacyloxysilanes.

Monomeric acyloxysilanes can comprise the formula

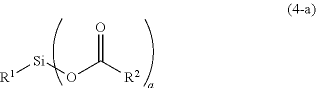

where subscript a has an average value greater than 2.0, alternatively subscript a has an average value ranging from greater than 2.0 to 4.0, alternatively subscript a may have an average value ranging from 2.3 to 3.4, and alternatively subscript a may have an average value ranging from 3.0 to 4.0;

each R¹ is independently a monovalent hydrocarbon group, and

each R² is independently a hydrogen atom or an organic group.

Alternatively, each R¹ is independently an alkyl, alkenyl, aryl, aralkyl, or alkaryl group containing 1 to 20 carbon atoms. Alternatively, each R¹ is independently an alkyl group containing 1 to 11 carbon atoms, an aryl group containing 6 to 14 carbon atoms and an alkenyl group containing 2 to 12 carbon atoms. Alternatively, each R¹ is methyl, propyl, or octyl.

Alternatively each R² may be a hydrogen atom, an alkyl group, an aryl group, an aralkyl group, or an alkaryl group. Alternatively, each R² is a methyl, phenyl, benzyl, ethyl, propyl, cyclopentyl, or cyclohexyl group.

Alternatively, in the formula above, when a is 2, 3, or 4, then two R² groups may be divalent, such that they form a ring structure, i.e., such that a diacyloxy group is bonded to silicon. For example, when a is 2, each R² may be a —CH₂— group.

Alternatively, the acyloxysilane may be an acetoxysilane (i.e., where each R² in the formula above is methyl group.) Exemplary acetoxysilanes include, but are not limited to, tetraacetoxysilane, methyltriacetoxysilane, ethyltriacetoxysilane, vinyltriacetoxysilane, propyltriacetoxysilane, butyltriacetoxysilane, phenyltriacetoxysilane, octyltriacetoxysilane, dimethyldiacetoxysilane, phenylmethyldiacetoxysilane, vinylmethyldiacetoxysilane, diphenyldiacetoxysilane, tetraacetoxysilane, and combinations thereof. Alternatively, the acetoxysilane may be selected from methyltriacetoxysilane, ethyltriacetoxysilane, propyltriacetoxysilane, octyltriacetoxysilane, dimethyldiacetoxysilane, and combinations thereof. In one embodiment, a triacetoxysilane and a diacetoxysilane may be used in combination. For example, methyltriacetoxysilane and dimethyldiacetoxysilane may be used in combination. In another embodiment, two or more triacetoxysilanes may be used in combination. For example, methyltriacetoxysilane and ethyltriacetoxysilane may be used in combination.

These and other acyloxysilanes can be produced through methods known in the art or purchased from suppliers such as Dow Corning Corporation of Midland, Mich., USA and Gelest of Philadelphia, Pa., USA. Furthermore, while specific examples of acyloxysilanes are explicitly listed herein, the above-disclosed examples are not intended to be limiting in nature. Rather, the above-disclosed list is merely exemplary and other acyloxysilanes, such as oligomeric acyloxysilanes and polyfunctional acyloxysilanes, may also be used.

When more than one acyloxysilane (i.e., a plurality of acyloxysilanes) is used in the method described above, each acyloxysilane comprises a mole percent of a total acyloxysilane concentration. For example, where the plurality of acyloxysilanes comprises only two acyloxysilanes, the first acyloxysilane will comprise X mole percent of the total acyloxysilane concentration while the second acyloxysilane will comprise 100-X mole percent of the total acyloxysilane concentration. To promote the formation of a silicone resin when treating the cellulosic substrate with the plurality of acyloxysilanes as will become appreciated herein, the total acyloxysilane concentration of the plurality of acyloxysilanes can comprise 20 mole percent or less of monoacyloxysilanes, 70 mole percent or less of monoacyloxysilanes and diacyloxysilanes (i.e., the total amount of monoacyloxysilanes and diacyloxysilanes when combined does not exceed 70 mole percent) of the total acyloxysilane concentration, and at least 30 mole percent of triacyloxysilanes and/or tetraacyloxysilanes (i.e., the total amount of triacyloxysilanes and/or tetraacyloxysilanes when combined comprises at least 30 mole percent of the total acyloxysilane concentration). In another embodiment, total acyloxysilane concentration of the plurality of acyloxysilanes can comprise 30 mole percent to 80 mole percent of triacyloxysilanes and/or tetraacyloxysilanes, or alternatively, 50 mole percent to 80 mole percent of triacyloxysilanes and/or tetraacyloxysilanes.

For example, when a plurality of acyloxysilanes is used in the method, the first acyloxysilane can comprise a first triacyloxysilane (such as one of methyltriacetoxysilane or ethyltriacetoxysilane) and the second acyloxysilane can comprise a second (different) triacyloxysilane (such as the other of methyltriacetoxysilane or ethyltriacetoxysilane). The first and second acyloxysilanes can be combined such that the first triacyloxysilane can comprise X percent of the total acyloxysilane concentration where X is 90 mole percent to 50 mole percent, 80 mole percent to 55 mole percent, or 65 mole percent to 55 mole percent. The ranges are intended to be exemplary only, and not limiting, and other variations or subsets may alternatively be utilized. Alternatively, the first acyloxysilane can comprise a triacyloxysilane (such as methyltriacetoxysilane) and the second acyloxysilane can comprise a diacyloxysilane (such as dimethyldiacetoxysilane).

The acyloxysilane can penetrate the substrate when the acyloxysilane is in a vapor or liquid form. Alternatively, the acyloxysilane may be applied to the substrate as one or more liquids. Specifically, when a plurality of acyloxysilanes is used (i.e., a first acyloxysilane, a second acyloxysilane and any additional acyloxysilanes) the plurality of acyloxysilanes can be applied to the substrate as a liquid, either alone or in combination, with other acyloxysilanes. As used herein, liquid refers to a fluid material having no fixed shape. In one embodiment, the acyloxysilanes, alone or in combination, can comprise liquids themselves. In another embodiment, each acyloxysilane can be provided in a solution (wherein the first acyloxysilane is combined with a solvent prior to treatment of the substrate) to create or maintain a liquid state. As used herein, “solution” comprises any combination of a) one or more acyloxysilanes and b) one or more other ingredients in a liquid state. The other ingredient may be a solvent, a surfactant, or a combination thereof. In such an embodiment, the acyloxysilane may originally comprise any form such that it combines with the solvent to form a liquid solution. In yet another embodiment, a plurality of acyloxysilanes can be provided in a single solution (e.g., wherein the first acyloxysilane and the second acyloxysilane are combined with a solvent prior to treatment of the substrate). The plurality of acyloxysilanes, either alone or in any combination, may thereby comprise a liquid or comprise any other state that combines with a solvent to comprise a liquid so that the acyloxysilanes are applied to the substrate as one or more liquids. The various acyloxysilanes may therefore be applied as one or more liquids simultaneously, sequentially or in any combination thereof, onto the substrate.

Alternatively, without intending to be limited to the exemplary embodiments expressly disclosed herein, the acyloxysilane or a solution can be applied to the substrate in vapor form by passing the substrate through a chamber containing vapor of the acyloxysilane or introducing an acyloxysilane in vapor form directly onto the surface of the substrate.

### Solvent

Thus, in one embodiment, an acyloxysilane solution (solution) can be produced by combining at least a first acyloxysilane (and any additional acyloxysilanes) with a solvent. A solvent is defined as a substance that will either dissolve the acyloxysilane to form a liquid solution or substance that provides a stable emulsion or dispersion of acyloxysilane that maintains uniformity for sufficient time to allow penetration of the substrate. Appropriate solvents can be non-polar such as non-functional silanes (i.e., silanes that do not contain a reactive functionality with the other ingredients in the solution, such non-functional silanes being exemplified by tetramethylsilane), silicones, alkyl hydrocarbons, aromatic hydrocarbons, or hydrocarbons possessing both alkyl and aromatic groups; polar solvents from a number of chemical classes such as ethers, ketones, esters, thioethers, halohydrocarbons; and combinations thereof.

Examples of non-polar solvents suitable for use in the method described herein include the hydrocarbon alkanes such as pentane, hexane, heptane, octane, cyclopentane, cyclohexane, cycloheptane, cycloctane, and combinations thereof; and aromatic hydrocarbons such as, benzene, toluene, xylene, and combinations thereof. Examples of polar solvents include esters, ketones, ethers, alcohols, weak organic acids, or acid anhydrides such as methylacetate, ethylacetate, propylacetate, butylacetate, benzylacetate, acetone, methylethylketone, diethylketone, dimethylether, diethylether, dipropylether, methyl-t-butylether, methanol, ethanol, isopropanol, acetic acid, propionic acid, butyric acid, acetic anhydride, isobutyric anhydride, maleic anhydride crotonic anhydride, chloroacetic anhydride, and combinations thereof. Specific nonlimiting examples of appropriate solvents include isopentane, pentane, hexane, heptane, petroleum ether, ligroin, benzene, toluene, xylene, naphthalene, α- and/or β-methylnaphthalene, diethylether, tetrahydrofuran, dioxane, methyl-t-butylether, acetone, methylethylketone, methylisobutylketone, methylacetate, ethylacetate, butylacetate, diethylether, alcohols (such as methanol, ethanol, propanol, or isopropanol), acetic acid, dimethylthioether, diethylthioether, dipropylthioether, dibutylthioether, dichloromethane, chloroform, chlorobenzene, tetramethylsilane, tetraethylsilane, hexamethyldisiloxane, octamethyltrisiloxane, hexamethylcyclotrisiloxane, octamethylcyclotetrasiloxane, decamethylcyclopentasiloxane, and combinations thereof. Alternatively, the solvent may comprises a hydrocarbon alkane such as pentane, hexane or heptane. Alternatively, the solvent may comprise a polar solvent such as methylacetate. Other exemplary solvents include toluene, naphthalene, isododecane, petroleum ether, tetrahydrofuran (THF), or silicones.

Alternatively, the solvent may comprise water. Water alone may be used as the solvent, or water may be used in combination with one or more other solvent(s) described above. Alternatively, in one embodiment, the acyloxysilane may be combined with water to precondense and/or prehydrolyze the acyloxysilane before penetrating the substrate. One skilled in the art would recognize that the amount of water and the conditions such as temperature and pH for this precondensation and/or prehydrolysis step are such that prepolymers may form. For purposes of this application, the term ‘prepolymers’ refers to molecules, which are reaction products of the acyloxysilane and water, but which are capable of penetrating the substrate and thereafter further reacting to form the silicone resin in the interstitial spaces of the substrate. Prepolymers may be, for example, silanol functional compounds or oligomers of the acyloxysilane. One skilled in the art would recognize that the method described herein using the acyloxysilane may alternatively use the prepolymer in addition to, or instead of, the acyloxysilane.

The at least a first acyloxysilane can be combined to produce the acyloxysilane solution through any available mixing mechanism. The acyloxysilanes can be either miscible or dispersible with the solvent to allow for a uniform solution, emulsion, or dispersion.

### Additional Ingredients

The solution may optionally further comprise a catalyst, a surfactant, or a combination thereof. The catalyst may be any suitable condensation reaction type catalyst known in the art of silicone chemistry. Alternatively, the catalyst may be added in the method even when solvent is not used.

### Catalyst

Examples of suitable catalysts include amines, such as triethyl amine, ethylenetriamine; quaternary ammonium compounds, such as benzyltrimethylammoniumhydroxide, beta-hydroxyethylltrimethylammonium-2-ethylhexoate and beta-hydroxyethylbenzyltrimethyldimethylammoniumbutoxide; and complexes of lead, tin, zinc, titanium, zirconium, bismuth, and iron.

Suitable tin catalysts include tin (IV) compounds and tin (II) compounds. Examples of tin (IV) compounds include dibutyl tin dilaurate (DBTDL), dimethyl tin dilaurate, di-(n-butyl)tin bis-ketonate, dibutyl tin diacetate, dibutyl tin maleate, dibutyl tin di acetylacetonate, dibutyl tin dimethoxide carbomethoxyphenyl tin tris-uberate, isobutyl tin triceroate, dimethyl tin dibutyrate, dimethyl tin di-neodeconoate (DMDTN), triethyl tin tartrate, dibutyl tin dibenzoate, butyltintri-2-ethylhexoate, a dioctyl tin diacetate, tin octylate, tin oleate, tin butyrate, tin naphthenate, dimethyl tin dichloride, and a combination thereof. Tin (IV) compounds are known in the art and are commercially available, such as METATIN® 740 and FASCAT® 4202.

Examples of tin (II) compounds include tin (II) salts of organic carboxylic acids such as tin (II) diacetate, tin (II) dioctanoate, tin (II) diethylhexanoate, tin (II) dilaurate, stannous salts of carboxylic acids such as stannous octoate, stannous oleate, stannous acetate, stannous laurate, and a combination thereof.

Examples of organofunctional titanates include 1,3-propanedioxytitanium bis(ethylacetoacetate); 1,3-propanedioxytitanium bis(acetylacetonate); titanium diisopropoxydiacetylacetonate; 2,3-di-isopropoxy-bis(ethylacetate)titanium; titanium naphthenate; tetra-propyl titanate; tetrabutyltitanate; tetra-ethylhexyl titanate; tetraphenyltitanate; tetra-octadecyl titanate; tetra-butoxy titanium; tetra-isopropoxy titanium; ethyltriethanolaminetitanate; a betadicarbonyltitanium compound such as bis(acetylacetonyl)di-isopropyl titanate; or a combination thereof. Siloxytitanates are exemplified by tetrakis(trimethylsiloxy)titanium, bis(trimethylsiloxy)bis(isopropoxy)titanium, or a combination thereof. Examples of condensation reaction catalysts are disclosed in, for example, U.S. Pat. Nos. 4,962,076; 5,051,455; and 5,053,442 and EP 1 746 133 paragraphs [0086] to [0122] for examples of condensation reaction catalysts. Alternatively, the catalyst may be dibutyltin diacetate, iron(III) acetylacetonate and/or titanium diisopropoxydiacetylacetonate.

### Surfactant

A surfactant may optionally be combined with the acyloxysilane or the solution to assist in the application of the acyloxysilane to the substrate. Surfactants are defined herein as any compound that lowers the surface tension of the acyloxysilane and/or the interfacial tension between the solution and the substrate to allow for greater spreading and carrying of the acyloxysilane onto and into the substrate. Examples include nonionic surfactants such as polyoxyethylene alkyl ethers, polyoxyethylene alkyl phenyl ethers, polyoxyethylene carboxylate, sorbitan fatty acid esters, polyoxyethylene sorbitan fatty acid esters, and polyether-modified silicones; cationic surfactants such as alkyltrimethylammonium chloride and alkylbenzylammonium chloride; anionic surfactants such as alkyl or alkylallyl sulfates, alkyl or alkylallyl sulfonates, and dialkyl sulfosuccinates; and ampholytic surfactants such as amino acid and betaine type surfactants. Suitable surfactants such as alkylethoxylates are commercially available. Other suitable surfactants include silicone polyethers, which are commercially available from Dow Corning Corporation of Midland, Mich., U.S.A. Other suitable surfactants include fluorinated hydrocarbon surfactants, fluorosilicone surfactants, alkyl and/or aryl quaternary ammonium salts, polypropyleneoxide/polyethyleneoxide copolymers such as PLURONICS® from BASF, or alkyl sulfonates.

The solution may comprise 0.1% to 50% of the acyloxysilane, 0% to 8% catalyst based on the weight of the acyloxysilane (alternatively 0.01% to 8% catalyst), 0% to 5% surfactant based on the weight of the acyloxysilane (alternatively 0.01% to 5% surfactant), where the balance of the solution is the solvent.

### Method

The substrate is treated with the acyloxysilane (either neat or in solution) to render the substrate hydrophobic. When the substrate is treated with the acyloxysilane neat, then one or more acyloxysilanes may be applied to the substrate without any other ingredients present in the acyloxysilane. The term “treated” (and its variants such as “treating,” “treat” and “treatment”) means in an appropriate environment for a sufficient amount of time, allowing for the acyloxysilane to penetrate the substrate and react to form a silicone resin. The term “penetrate” (and its variants such as “penetrating,” “penetration”, “penetrated”, and “penetrates”) means that the acyloxysilane enters some or all of the interstitial spaces of the substrate, and the acyloxysilane does not merely form a surface coating on the substrate. As used herein, the term “penetrate” (and its variants such as “penetrating,” “penetration”, “penetrated”, and “penetrates”) excludes forming a slurry of 1) a particulate or powder with 2) the acyloxysilane (either neat or in solution) and/or a prepolymer thereof. Without intending to be bound by a particular theory or mechanism, it is thought that the acyloxysilane can react with the —OH functionality of the cellulosic substrate, when a cellulosic substrate is used, and/or the acyloxysilane can react with water within the substrate and/or other sizing agents or additional additives containing —OH functionality in the substrate to form the silicone resin. The silicone resin refers to any product of the reaction between the acyloxysilane and the —OH functionality in the substrate and/or the water within the substrate, which renders the substrate hydrophobic. For example, the acyloxysilane capable of forming two or more bonds can react with the hydroxyl groups distributed along the cellulose chains of the cellulosic substrate and/or the water contained therein to form a silicone resin disposed throughout the interstitial spaces of the cellulosic substrate and anchored to the cellulose chains of the cellulosic substrate. Where the acyloxysilane reacts with the water in the substrate, the reaction can produce acetic acid as a byproduct and a silanol. The silanol may then further react with an acyloxysilane or another silanol to produce the silicone resin. The different reaction mechanisms can continue substantially all or part way through the thickness of the substrate, thereby treating a part of the volume or the entire volume of a substrate in which the acyloxysilane has penetrated. When the acyloxysilane penetrates all the way through the thickness of the substrate, the entire volume of the substrate can be treated.

Penetrating the substrate with the acyloxysilane can be achieved in a variety of ways. For example, without intending to be limited to the exemplary embodiments expressly disclosed herein, the acyloxysilane or a solution can be applied to the substrate by being dropped onto the substrate (e.g., from a nozzle or die), by being sprayed (e.g., through a nozzle) onto one or more surfaces of the substrate, by being poured onto the substrate, by immersion (e.g., by passing the substrate through a contained amount of the acyloxysilane or solution, or by dipping the substrate into the acyloxysilane or solution), or by any other method that can coat, soak, or otherwise allow the acyloxysilane to come into physical contact with the substrate and enter interstitial spaces in the substrate. In one embodiment, where more than one acyloxysilane is used and the acyloxysilanes are applied separately (e.g., not as one single acyloxysilane or solution), the first acyloxysilane, the second acyloxysilane, and any additional acyloxysilane can be applied simultaneously or sequentially to the substrate or in any other repeating or alternating order. Alternatively, where a combination of separate acyloxysilanes and solutions are used, the acyloxysilanes and solutions may be also be applied simultaneously or sequentially or in any other repeating or alternating order.

For example, in one embodiment, where the substrate is a cellulosic substrate comprising a roll of paper, the paper can be unrolled at a controlled velocity and passed through a treatment area where the acyloxysilane is dropped onto the top surface of the paper. The velocity of the paper can depend in part on the thickness of the paper and/or the amount of acyloxysilane to be applied and can range from 1 feet/minute (ft./min.) to 3000 ft./min., alternatively from 10 ft./min. to 1000 ft./min., and alternatively from 20 ft./min to 500 ft./min. In one embodiment, within the treatment area one or more nozzles drop a solution onto one or both surfaces of the cellulosic substrate so that one or both surfaces of the cellulosic substrate are covered with the solution.

The substrate treated with the acyloxysilane can then rest, travel or experience additional treatments to allow for the acyloxysilane to react with the substrate and the water therein. For example, to allow for an adequate amount of time for reaction, the substrate may be stored in a heated, cooled and/or humidity-controlled chamber and allowed to remain for an adequate residence time, or may alternatively travel about a specified path wherein the length of the path is adjusted such that the substrate traverses the specified path in an amount of time adequate for the reaction to occur.

Without wishing to be bound by theory, it is thought that this method may provide the benefit that it is unnecessary to expose the treated substrate to a basic compound (such as ammonia gas) after the acyloxysilane reacts to form the resin.

To increase the rate of reaction, the substrate can also optionally be heated and/or dried after the acyloxysilane penetrates, to produce the silicone resin in the substrate. For example, the substrate may be in a drying chamber in which heat is applied to the substrate. The temperature of the drying chamber will depend on the type of substrate and its residence time therein, however, the temperature in the chamber may comprise a temperature in excess of 200° C., alternatively up to 95° C., alternatively room temperature (of 25° C.) to 95° C., and alternatively 55° C. to 70° C. Alternatively, when a cellulosic substrate is used and the cellulosic substrate passes through the drying chamber, the temperature therein can vary depending on factors including the type of cellulosic substrate, the speed in which the cellulosic substrate passes through the drying chamber, the thickness of the cellulosic substrate, and/or the amount of the acyloxysilane applied to the cellulosic substrate. For example, when the cellulosic substrate is paper, the temperature may range from room temperature to 95° C., and alternatively 55° C. to 70° C.

Once the substrate is treated to render it hydrophobic, the hydrophobic substrate will comprise the silicone resin from the reaction between the acyloxysilane and the water within the substrate and/or —OH groups within the substrate (such as a cellulosic substrate) as discussed above. The content of silicone resin depends on the type of substrate and the amount of acyloxysilane used in the method, however, the hydrophobic substrate may contain silicone resin in an amount ranging from greater than 0% of the substrate to 10% of the substrate, alternatively 0.01% to less than 10%, alternatively 0.01% to 0.99%, alternatively 0.1% to 0.9%, and alternatively 0.3% to 0.8%, and alternatively 0.3% to 0.5%. The balance may be the substrate. When the substrate is paper, the silicone resin may be present in an amount ranging from 0.01% to 0.99%, alternatively 0.1% to 0.9%, and alternatively 0.3% to 0.8%, and alternatively 0.3% to 0.5%. The percent refers to the weight of the silicone resin (formed from the reaction of the acyloxysilane) with respect to the overall weight of both the substrate and the silicone resin.

Furthermore, it has been surprisingly found that biodegradable substrates may be rendered hydrophobic, while maintaining their biodegradability, by the method described herein. The amount of silicone resin in the substrate need not be as high as in previously disclosed treatment methods; it has been found that greater than 0% to less than 1%, alternatively 0.01% to 0.99%, alternatively, 0.1% to 0.9%, alternatively 0.3% to 0.8%, and alternatively 0.3% to 0.5% silicone resin in the substrate provides sufficient hydrophobicity for certain applications described herein, such as packaging material and disposable food service articles, while still maintaining the biodegradability of the substrate. Without wishing to be bound by theory, it is thought that higher amounts of resin than described above may make the substrate more difficult to compost the substrate at the end of its useful life.

### EXAMPLES

The following examples are included to demonstrate the invention to one of ordinary skill. However, those of ordinary skill in the art should, in light of the present disclosure, appreciate that many changes can be made in the specific embodiments which are disclosed and still obtain a like or similar result without departing from the spirit and scope of the invention. In the description, ‘Me’ represents a methyl group, ‘Et’ represents an ethyl group, and ‘OAc’ represents an acetoxy group.

### Reference Example 1

### Treatment Procedure, Cobb Sizing Test and Immersion Test, and Strength Evaluation

Unbleached kraft papers (24 pt and 45 pt), which were light brown in color, were treated with various solutions containing either chlorosilane(s) or acetoxysilane(s) in either pentane or methylacetate. The papers were drawn through a machine as a moving web where the treatment solution was applied. The line speed was typically 10 feet/minute to 30 ft/min, and the line speed and flow of the treating solution were adjusted so that complete soak-through of the paper was achieved. The paper was then exposed to sufficient heat and air circulation to remove solvent and volatile silane. In cases where chlorosilanes were used, the paper was subjected to an additional step of exposing it to an atmosphere of ammonia to neutralize HCl. The hydrophobic attributes of the treated papers were then evaluated via the Cobb sizing test and immersion in water for 24 hours.

The Cobb sizing test was performed in accordance with the procedure set forth in TAPPI testing method T441 where a 100 cm² surface of the paper was exposed to 100 milliliters (mL) of 50° C. deionized water for three minutes. The reported value was the mass (g) of water absorbed per square meter (g/m²) by the treated paper.

The immersion test was conducted by completely immersing 6″×6″ (15.24 cm×15.24 cm) pieces of treated paper in a bath of deionized water for a uniform period of time (e.g., 24 hours) in accordance with TAPPI testing method T491. The uptake of water by the paper was expressed as a percent weight gain. The strength properties of the paper were further evaluated by measuring the tensile strength of 1″ (2.54 cm) wide strips cut from both the machine direction (MD) and cross direction (CD) of the paper as set forth in TAPPI testing method T494. The machine direction referred to the direction in which the fibers in the paper were generally aligned as influenced by the direction of feeding through the machine when the cellulosic substrate was made. The cross direction referred to the direction perpendicular to the direction in which the fibers in the paper generally aligned.

The dry and wet tear values were evaluated in accordance with the procedure set forth in TAPPI test method T414. Treated papers were soaked in water at 22° C. for one hour before performing measurements to obtain the wet tear values. Strength properties were tested in both the machine direction (MD) and the cross direction (CD). The deposition efficiency was calculated from the amount of chlorosilane(s) or acetoxysilane(s) applied to the cellulosic substrate using the known variables of solution concentration, solution application rate, and paper feed rate. The amount of resin contained in the treated paper was determined by converting the resin to monomeric siloxane units and quantifying such using gas chromatography pursuant to the procedure described in “The Analytical Chemistry of Silicones,” Ed. A. Lee Smith. Chemical Analysis Vol. 112, Wiley-Interscience (ISBN 0-471-51624-4), pp 210-211. The deposition efficiency was then determined by dividing the amount of resin in the paper by the amount of chlorosilane(s) or acetoxysilane(s) applied.

### Example 1

### Comparison of Chlorosilane Treatment to Acetoxysilane Treatment

To 24 pt unsized kraft paper pieces were applied a number of solutions containing either methyltrichlorosilane (MeSiCl₃) (Comparative solutions 1, 2, 3, and 4) or methyltriacetoxysilane (MeSi(OAc)₃) in pentane (Solutions 5, 6, and 7). Concentrations of the two systems were chosen such that the amount of resin formed in the paper would span an equivalent range. The concentrations of the solutions are shown below in Table 1. The solutions containing MeSi(OAc)₃ also contained dibutyltindiacetate at a level of 1 mol % relative to Si atom to function as a catalyst to speed cure and formation of resin within the paper.

The results for the water resistance and strength testing are shown in Table 2. Both MeSiCl₃ and MeSi(OAc)₃ imparted significant water resistance relative to untreated paper in these examples, as exhibited by the results of the Cobb sizing test and Immersion results measured according to the method of Reference Example 1. Due to the slightly higher values of Cobb, it is thought that the resin may not have been fully cured within the paper in the case of treatments using MeSi(OAc)₃. However, the paper treated with MeSiCl₃ solutions in Comparative solutions 1, 2, 3, and 4 exhibited tensile strengths decreasing with increasing MeSiCl₃ concentration, especially in the machine direction, relative to untreated paper. Not to be bound by a particular theory, it is likely that the formation of HCl, resulting from the reaction of MeSiCl₃ with the moisture in the paper, had a detrimental effect on the paper fibers by cleaving the cellulose chains. In contrast, treatment with MeSi(OAc)₃ solutions (5, 6, and 7) enhanced the tensile strength of the paper, particularly in the machine direction.

In addition, there was a significant difference between the chlorosilane and acetoxysilane based treatments in the efficiency of the deposition of the silane into the paper. As can be seen in Table 2, lower concentrations MeSi(OAc)₃ were needed to achieve the same amount of resin in the paper as the MeSiCl₃ treatments, where higher concentrations were required. The deposition efficiency of the MeSi(OAc)₃ system was 80% compared to 20% for the MeSiCl₃ solutions in comparative solutions 1-4 and exemplary solutions 5-7.

TABLE 1
Representative chlorosilane and acetoxysilane solutions used in the
treatment of cellulosic substrates. Solutions of acetoxysilanes also
contain 1 mol % (relative to Si atoms) of dibutyltindiacetate catalyst.

| Solutions | Silane | Concentration (wt %) | Solvent |
|---|---|---|---|
| Comparative 1 | MeSiCl₃ | 5.0 | Pentane |
| Comparative 2 | MeSiCl₃ | 10 | Pentane |
| Comparative 3 | MeSiCl₃ | 20 | Pentane |
| Comparative 4 | MeSiCl₃ | 50 | Pentane |
| 5 | MeSi(OAc)₃ | 1.5 | Pentane |
| 6 | MeSi(OAc)₃ | 3.7 | Pentane |
| 7 | MeSi(OAc)₃ | 7.3 | Pentane |

TABLE 2
Water resistance and strength properties of cellulosic substrates (untreated
and treated) with chlorosilane solutions and acetoxysilane solutions (where
MD denotes machine direction and CD denotes cross direction). Solutions
were delivered from pentane and 24 pt. paper was used. Solutions of
acetoxysilanes also contained 1 mol % (relative to Si atoms) of
dibutyltindiacetate catalyst.

| | | Comparative | | | | | | |
|---|---|---|---|---|---|---|---|---|
| Solution | None | 1 | 2 | 3 | 4 | 5 | 6 | 7 |
| Treatment Level (wt %) | Untreated | 5.0 | 10 | 20 | 50 | 1.5 | 3.7 | 7.3 |
| | Paper | | | | | | | |
| Cobb Value (g/m²) | | | | | | | | |
| Topside | 700 | 43 | 40 | 32 | 36 | 58 | 58 | 48 |
| Backside | 716 | 42 | 33 | 44 | 39 | 56 | 56 | 52 |
| Immersion (24 h, wt %) | 154 | 63 | 60 | 64 | 65 | 80 | 81 | 76 |
| Tensile (lbs.) | | | | | | | | |
| MD | 151 | 145 | 137 | 140 | 135 | 155 | 161 | 176 |
| CD | 67.1 | 66.3 | 65.3 | 68.2 | 67.4 | 68.5 | 76.7 | 69.5 |
| Resin content of paper (wt %) | — | 0.18 | 0.30 | 0.47 | 0.83 | 0.15 | 0.38 | 0.78 |
| Deposition Efficiency (%) | — | 22 | 19 | 16 | 10 | 84 | 76 | 74 |

### Example 2

Paper (24 pt unsized kraft) was then treated with solutions containing increasing concentrations of a 50:50 mixture of MeSi(OAc)₃ and EtSi(OAc)₃ in methyl acetate (see Table 3, solutions 8 through 14). Also included in each solution, was 1 mol %, relative to Si atom, of titanium diisopropoxide bis(acetylacetonate) to act as a catalyst to speed cure of the resin in the system. The treated paper exhibited significantly better water resistance than that of the untreated paper as evidenced by the Cobb and Immersion values in Table 4. In general, the water resistance improved as the concentration of the acetoxysilane mixture increased in this example. These values were also comparable to the values obtained for the Comparative (1 through 4) chlorosilane solutions in Table 2, likely due to the use of a more efficient catalyst system. The tensile strength of paper treated with solutions 8 through 14 also increased as the amount of resin formed within the paper increased. While some samples showed improved dry tear values relative to the untreated paper, the wet tear values increased significantly. The deposition efficiency obtained from the use of a mixture of acetoxysilanes (MeSi(OAc)₃ and EtSi(OAc)₃) versus that of a single acetoxysilane (MeSi(OAc)₃, as in Example 1) also increased the deposition efficiency from 80% (as shown in Table 4) to greater than 90% (as shown in Table 2.

TABLE 3
Representative acetoxysilane compositions used in the treatment of
cellulosic substrates, in which a 50/50 blend of MeSi(OAc)₃ and
EtSi(OAc)₃ was used in the solutions. Solutions of acetoxysilanes
also contained 1 mol % (relative to Si atoms) of titanium
diisopropoxide bis(acetylacetonate) catalyst.

| | Concentration of | |
|---|---|---|
| | acetoxysilane | Solvent used as |
| Solutions | mixture (wt %) | balance of solution |
| 8 | 1 | Methyl acetate |
| 9 | 5 | Methyl acetate |
| 10 | 10 | Methyl acetate |
| 11 | 20 | Methyl acetate |
| 12 | 30 | Methyl acetate |
| 13 | 40 | Methyl acetate |
| 14 | 50 | Methyl acetate |

TABLE 4
Water resistance and strength properties of cellulosic substrates (untreated
and treated).

| Solution | None | 8 | 9 | 10 | 11 | 12 | 13 | 14 |
|---|---|---|---|---|---|---|---|---|
| Treatment Level (wt %) | Untreated | 1.0 | 5.0 | 10 | 20 | 30 | 40 | 50 |
| | Paper | | | | | | | |
| Cobb Value (g/m²) | | | | | | | | |
| Topside | 651 | 52 | 44 | 44 | 42 | 33 | 30 | 59 |
| Backside | 648 | 50 | 50 | 48 | 46 | 36 | 26 | 67 |
| Immersion (24 h, wt %) | 154 | 76 | 68 | 69 | 71 | 68 | 66 | 65 |
| Tensile (lbs.) | | | | | | | | |
| MD | 155 | 167 | 165 | 171 | 184 | 200 | 200 | 191 |
| CD | 68.4 | 72.4 | 70.4 | 75.8 | 75.4 | 83.9 | 89.7 | 88.3 |
| Dry Tear (g) | | | | | | | | |
| MD | 465 | 456 | 482 | 478 | 492 | 480 | 474 | 466 |
| CD | 844 | 766 | 689 | 988 | 943 | 728 | 611 | 743 |
| Wet Tear | | | | | | | | |
| MD | 231 | 456 | 543 | 482 | 549 | 639 | 629 | 632 |
| CD | 310 | 534 | 579 | 566 | 621 | 721 | 754 | 742 |
| Resin content of paper (wt %) | — | 0.13 | 0.75 | 1.3 | 3.0 | 4.5 | 5.7 | 5.8 |
| Deposition Efficiency (%) | — | 90 | 100* | 92 | 100* | 100* | 97 | 85 |

*Due to the complex mixture of components and variation in the analytical technique, the calculated deposition efficiency surpassed 100% in these instances.

### Example 3

In this example, paper (24 pt unsized kraft) was treated with solutions containing the same mixture of triacetoxysilanes as used in Example 2 and dimethyldiacetoxysilane (Me₂Si(OAc)₂). The ratios of the triacetoxysilane mixture (from example 2) and diacetoxysilane (Me₂Si(OAc)₂) were varied to impregnate the paper with resins of varying brittleness and toughness (as shown in Table 5). Each solution also contained a catalyst, titanium diisopropoxide bis(acetoacetonate) at a level of 1 mole % relative to Si atom.

Each paper treated with solutions 15 through 24 exhibited significant water resistance relative to untreated paper. Paper treated with solutions 20 and 21 exhibited the greatest increase in strength relative to the untreated paper. All combinations impacted the machine direction dry tear values in a positive manner relative to untreated paper. All wet tear values for paper treated with solutions 15 through 24 were significantly increased over that of the untreated paper.

TABLE 5
Representative acetoxysilane compositions used in the treatment
of cellulosic substrates. A 50/50 blend of MeSi(OAc)₃ and
EtSi(OAc)₃ was used as one of the acetoxysilane components.
Solutions of acetoxysilanes also contained 1 mol % (relative to
Si atoms) of titanium diisopropoxide bis(acetylacetonate) catalyst.

| | | | Relative Concentration | |
|---|---|---|---|---|
| | Concentration | | mol % | |
| Solutions | (wt %) | Solvent | Mixture | Me₂Si(OAc)₂ |
| 15 | 1 | Methyl acetate | 90 | 10 |
| 16 | 1 | Methyl acetate | 80 | 20 |
| 17 | 1 | Methyl acetate | 70 | 30 |
| 18 | 1 | Methyl acetate | 60 | 40 |
| 19 | 1 | Methyl acetate | 50 | 50 |
| 20 | 10 | Methyl acetate | 90 | 10 |
| 21 | 10 | Methyl acetate | 80 | 20 |
| 22 | 10 | Methyl acetate | 70 | 30 |
| 23 | 10 | Methyl acetate | 60 | 40 |
| 24 | 10 | Methyl acetate | 50 | 50 |

TABLE 6
Water resistance and strength properties of cellulosic substrates (untreated
and treated) with acetoxysilane solutions (where MD denotes machine direction and CD denotes
cross direction). Solutions were delivered from methyl acetate and 24 pt. paper was used.

| Solution | None | 15 | 16 | 17 | 18 | 19 | 20 | 21 | 22 | 23 | 24 |
|---|---|---|---|---|---|---|---|---|---|---|---|
| Treatment | Untreated | 1.0 | 1.0 | 1.0 | 1.0 | 1.0 | 10 | 10 | 10 | 10 | 10 |
| Level | Paper | | | | | | | | | | |
| (wt %) | | | | | | | | | | | |
| Cobb Value (g/m²) | | | | | | | | | | | |
| Topside | 651 | 49 | 50 | 52 | 54 | 52 | 42 | 44 | 50 | 44 | 44 |
| Backside | 648 | 54 | 52 | 53 | 56 | 60 | 47 | 51 | 52 | 48 | 44 |
| Immersion | 154 | 73 | 78 | 77 | 85 | 78 | 68 | 69 | 72 | 71 | 66 |
| (24 h, wt %) | | | | | | | | | | | |
| Tensile (lbs.) | | | | | | | | | | | |
| MD | 155 | 163 | 164 | 162 | 166 | 162 | 173 | 173 | 165 | 156 | 167 |
| CD | 68.4 | 68.9 | 72.5 | 68.4 | 67.7 | 68.3 | 74.9 | 73.1 | 70.8 | 70.3 | 72.4 |
| Dry Tear (g) | | | | | | | | | | | |
| MD | 465 | 468 | 498 | 476 | 474 | 493 | 526 | 516 | 517 | 551 | 500 |
| CD | 844 | 804 | 673 | 905 | 680 | 813 | 897 | 701 | 961 | 882 | 767 |
| Wet Tear | | | | | | | | | | | |
| MD | 231 | 382 | 522 | 518 | 413 | 458 | 499 | 508 | 632 | 423 | 592 |
| CD | 310 | 541 | 659 | 545 | 401 | 611 | 628 | 479 | 589 | 539 | 352 |

### Example 4

### Prehydrolysis of the Acyloxysilane

In this example, paper (45 pt unsized kraft) was treated with solutions containing the same mixture of triacetoxysilanes as used in Example 2 and methyl acetate solvent. The concentration (wt %) of triacetoxysilanes in methylacetate were varied. Water was added in various molar ratios to prehydrolyze and promote the condensation of the triacetoxysilane into oligomers before penetrating the paper with the solution. The performance of paper treated with these solutions was compared to paper treated with non-hydrolyzed, non-precondensed (no external water added) solutions of triacetoxysilanes. The solutions used are shown in Table 7. All solutions were loaded with 0.1 wt % (relative to the overall mass of the solution) titanium diisopropoxide bis(acetoacetonate). For the treatment, the solution was only applied to one side of the paper in sufficient volume to soak through the thickness of the paper. The Cobb and tensile values are noted in Table 8. Pre-hydrolysis and pre-condensation of the triacetoxysilanes prior to treating the paper had little effect on the ability of the solution to penetrate and treat the paper throughout the entire thickness as evidenced by the similarity between the topside and backside Cobb values. The performance was similar to that of the nonhydrolyzed, non-precondensed solutions. Water uptake as measured by immersion for 24 h did not vary substantially between the test examples with and without prehydrolysis. Though the results vary from the examples without prehydrolysis in terms of being higher in some cases or lower in others, the values for tensile strength were not adversely affected.

TABLE 7
Solutions of a 50/50 blend of MeSi(OAc)₃ and EtSi(OAc)₃ and solutions
of prehydrolyzed and precondensed triacetoxysilanes (originally 50/50
blend of MeSi(OAc)₃ and EtSi(OAc)₃) were used in the treatment of
cellulosic substrates. All solutions were made in methyl acetate and
contained 1 wt % (relative to total mass of solution) of titanium
diisopropoxide bis(acetylacetonate) catalyst. In this application,
‘Me’ refers to a methyl group, ‘Et’ refers to an ethyl group and
‘OAc’ refers to an acetoxy group.

Molar Ratios

| | Concentration | MeSi(OAc)₃ | |
|---|---|---|---|
| Solutions | (wt %) | & EtSi(OAc)₃ | Water |
| 25 | 5 | 1 | 0 |
| 26 | 5 | 1 | 1 |
| 27 | 5 | 1 | 2 |
| 28 | 5 | 1 | 2.5 |
| 29 | 10 | 1 | 0 |
| 30 | 10 | 1 | 1 |
| 31 | 10 | 1 | 2 |
| 32 | 10 | 1 | 2.5 |
| 33 | 20 | 1 | 0 |
| 34 | 20 | 1 | 1 |
| 35 | 20 | 1 | 2 |
| 36 | 20 | 1 | 2.5 |

TABLE 8
Water resistance and strength properties of cellulosic substrates (untreated and treated)
with triacetoxysilane solutions (where MD denotes machine direction and CD denotes
cross direction). Solutions were delivered from methyl acetate and 45 pt. paper was used.

| Solution | Untreated | 25 | 26 | 27 | 28 | 29 | 30 | 31 | 32 | 33 | 34 | 35 | 36 |
|---|---|---|---|---|---|---|---|---|---|---|---|---|---|
| Treatment | None | 5.0 | 5.0 | 5.0 | 5.0 | 10 | 10 | 10 | 10 | 20 | 20 | 20 | 20 |
| Level (wt %) | | | | | | | | | | | | | |
| Cobb Value (g/m²) | | | | | | | | | | | | | |
| Topside | 1042 | 49 | 49 | 51 | 48 | 52 | 47 | 52 | 46 | 41 | 42 | 44 | 46 |
| Backside | 1074 | 57 | 65 | 64 | 65 | 82 | 54 | 66 | 54 | 62 | 45 | 52 | 50 |
| Immersion | 108 | 65 | 69 | 73 | 73 | 79 | 64 | 61 | 59 | 62 | 65 | 68 | 69 |
| (24 h, wt %) | | | | | | | | | | | | | |
| Tensile (lbs.) | | | | | | | | | | | | | |
| MD | 244 | 200 | 219 | 210 | 201 | 228 | 212 | 207 | 211 | 255 | 230 | 225 | 210 |
| CD | 76 | 58.6 | 56.0 | 61.0 | 61.2 | 64.9 | 56.4 | 60.6 | 61.4 | 66.6 | 66.6 | 65.5 | 63.4 |

### Example 5

### SEM and EDS of Acetoxysilane Treated Paper

Scanning Electron Microscopy (SEM) and Energy Dispersive Spectroscopy (EDS) analyses were performed on some of the treated papers as prepared above. These papers were treated with varying levels of acetoxysilanes. The resulting images may help show how the treatment forms resin in the interstitial spaces between fibers making up the paper. SEM operating conditions were 15 kV accelerating voltage, 15 mm working distance, and aperture 4. EDS spectra were acquired at 150× magnification. Each spectrum included 1 mm² of sample area to minimize any differences that may have been caused due to non-uniform solution application to the paper.

Table 9, below, shows the average amount, in weight percent, of carbon, oxygen, sodium aluminum, silicon, sulfur, and calcium in the untreated and treated papers.

TABLE 9
Average amount (weight percent) of each element in each paper
sample as analyzed by EDS. Three measurements were taken
and averaged to obtain the average amounts.
In Table 9, ‘nm’ means ‘not measured.’

| Sample | C | O | Na | Al | Si | S | Ca | Cl |
|---|---|---|---|---|---|---|---|---|
| Untreated | 74 | 24 | 0.13 | 0.33 | 0.51 | 0.21 | 0.97 | nm |
| (comparative) | | | | | | | | |
| Solution 8 | 73 | 25 | 0.12 | 0.30 | 1.0 | 0.23 | 0.90 | nm |
| Solution 9 | 74 | 23 | 0.11 | 0.30 | 1.9 | 0.21 | 0.86 | 0.03 |
| Solution 10 | 74 | 22 | 0.08 | 0.35 | 2.5 | 0.22 | 0.83 | 0.04 |
| Solution 11 | 64 | 30 | 0.10 | 0.29 | 4.7 | 0.14 | 0.72 | 0.06 |
| Solution 13 | 65 | 27 | 0.09 | 0.22 | 7.0 | 0.17 | 0.55 | 0.06 |
| Solution 19 | 66 | 31 | 0.12 | 0.32 | 1.7 | 0.20 | 0.87 | 0.03 |
| Solution 24 | 66 | 30 | 0.12 | 0.38 | 2.2 | 0.23 | 1.1 | 0.04 |

Without wishing to be bound by theory, it is thought that the method described herein may provide the benefit that the silicone resin formed within the cellulose fibers of cellulosic substrates reinforces the cellulosic substrates both by bridging the cellulose fibers with chemical bonds to the silicon atom (via reaction with a portion of the —OH groups along the cellulose chain) and by forming a silicone resin network within the interstitial spaces between the fibers. In particular, such a silicone resin may strengthen cellulosic substrates comprising recycled fibers wherein the strength of the recycled fibers has been reduced with each recycling due to the reduction in length of cellulose fibers that occurs as a result of breaking down of the pulp. Thus, not only will the acyloxysilanes provide hydrophobic properties to the cellulosic structure, but other physical properties (such as, for example, wet tear strength and tensile strength) may also be maintained or improved relative to the untreated cellulosic substrate as a result of treatment with the acyloxysilanes.

In addition, it is further believed that by mixing different acyloxysilanes in varying ratios and amounts, the deposition efficiencies of the acyloxysilanes may increase allowing for the methods of rendering substrates hydrophobic to become more efficient by achieving greater acyloxysilane deposition during treatment.

Without wishing to be bound by theory, it is thought that treating paper with acyloxysilane can cause the Cobb value of the paper to drop from 500 g/m² to 600 g/m² for untreated paper to a value on the order of 50 g/m² for paper treated according to the method described herein. The Cobb values for paper treated according to the method described herein are similar to Cobb values observed for paper treated with chlorosilanes. During the reaction in which an acyloxysilane is used to treat paper, the most likely first step is the hydrolysis of the acetoxy group to form a silanol and liberate acetic acid. That silanol can either react with other silanols or with other acyloxysilane derivatives to form the resin. It may also react with the hydroxy groups of the cellulose fibers themselves. It is thought that this method is advantageous over the method for treating paper with chlorosilanes in that the method described herein does not form HCl as a byproduct, whereas treating paper with chlorosilanes forms HCl. The carboxylic acid byproducts, such as acetic acid, of the method herein are weaker acids than hydrogen halides such as HCl, which provides the advantage of a less corrosive process environment. This method may also provide the benefit of any hydronium ions that result from the dissociation of the carboxylic acid to be present in low concentration, thereby only affecting the pH of the substrate marginally (i.e., less than the hydronium ions produced by a hydrogen halide would), thereby not causing white paper treated by the method described herein to turn yellow during the useful life of the paper. In chlorosilane-based systems, the HCl formed as a result of the condensation reactions leads to the presence of a strong acid in the paper and requires a further treatment step to adjust the pH closer to neutral. The method herein has the advantage that the additional treatment step is not needed.

When chlorosilanes are used to render paper water-resistant, the concentrations of chlorosilanes must be kept relatively low, on the order of 2.5% to 5% because higher concentrations begin to introduce enough acid to be detrimental to the properties of the paper. However, treatment with acyloxysilanes provided appreciable improvements in the strength of the paper in the examples described above. Without wishing to be bound by theory, it is thought that by having higher boiling points and substantially lower vapor pressures than chlorosilanes, acyloxysilanes may exhibit significantly improved deposition onto and into the paper. For instance, a minimum concentration of 1.5 wt % methyltrichlorosilane (MeSiCl₃) in pentane is required to impart sufficient water-resistance as measured by Cobb values that are less than 80 g/m² to paper because so much MeSiCl₃ evaporates during the treatment method. Though more expensive initially, acyloxysilanes may have a lower cost-in-use than their chlorosilane counterparts because a significant majority of each acyloxysilane will remain in the paper even after the solvent flashes off; for example, a solution that is only 0.75% methyltriacetoxysilane in solvent is needed to obtain sufficient hydrophobicity of paper substrates for some applications.

1. A method comprising:
A) penetrating a substrate with an acyloxysilane and/or a prepolymer thereof, and
B) forming a resin from the acyloxysilane and/or the prepolymer.

2. The method of claim 1, where the acyloxysilane has formula 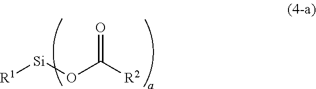
where subscript a has an average value greater than 2,
each R¹ is independently a monovalent hydrocarbon group, and
each R² is independently a hydrogen atom or an alkyl group of 1 to 4 carbon atoms.

3. (canceled)

4. The method of claim 1, where the acyloxysilane is in liquid form.

5. The method of claim 1, where the acyloxysilane is in vapor form.

6. The method of claim, further comprising adding a catalyst in step A)

7. The method of claim 1, where a solution comprising the acyloxysilane and a solvent is used in step A).

8.-11. (canceled)

12. The method of claim 1, where step A) is performed by dropping, spraying, or pouring the acyloxysilane onto one or more surfaces of the substrate, by passing the substrate through a contained amount of the acyloxysilane; or by dipping the substrate in the acyloxysilane.

13. (canceled)

14. The method of claim 7, where step A) is performed by exposing the substrate to the solution in vapor form.

15.-17. (canceled)

18. The method of claim 1, where the substrate is a cellulosic substrate.

19. (canceled)

20. (canceled)

21. A hydrophobic cellulosic substrate prepared by the method of claim 18.

22. The method of claim 1, where the substrate is a building material.

23. A hydrophobic building material prepared by the method of claim 22.

24. A hydrophobic substrate comprising:
a low surface area substrate; and,
0.01 weight percent to 10 weight percent of a silicone resin, wherein the silicone resin is produced from treating the substrate with an acyloxysilane and/or a prepolymer thereof.

25. (canceled)

26. (canceled)

27. The hydrophobic substrate of claim 2, where the cellulosic substrate comprises paper, cardboard, boxboard, wood, wood products, wallboard, or textiles.

28. (canceled)

29. The hydrophobic substrate of claim 2, where the substrate is a building material.

30. (canceled)

31. A method comprising:
1) penetrating a substrate with an acyloxysilane and/or a prepolymer thereof; and
2) forming a resin from the acyloxysilane and/or the prepolymer;
where the product of step 2) is both hydrophobic and biodegradable.

32.-34. (canceled)

35. The method of claim 31, further comprising: step 3) exposing the substrate to a basic compound, where the product of step 3) is both hydrophobic and biodegradable.

36.-44. (canceled)

45. The method of claim 31, where a solution comprising the acyloxysilane and a solvent is used in step 1).

46.-49. (canceled)

50. The method of claim 31, where step 1) is performed by dropping, spraying, or pouring the acyloxysilane or the solution onto one or more surfaces of the substrate, by passing the substrate through a contained amount of the acyloxysilane or the solution; or by dipping the substrate in the acyloxysilane or the solution.

51.-53. (canceled)

54. The method of claim 31, where the acyloxysilane has formula 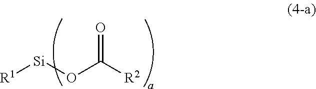
where subscript a has an average value greater than 2,
each R¹ is independently a monovalent hydrocarbon group, and
each R² is independently a hydrogen atom or an alkyl group of 1 to 4 carbon atoms.

55. (canceled)

56. (canceled)

57. An article comprising:
a cellulosic substrate; and,
0.01% to 0.99% of a silicone resin, where the resin is produced from treating the cellulosic substrate with an acyloxysilane and/or a prepolymer thereof, and the article is both hydrophobic and biodegradable.

58. (canceled)

59. (canceled)

60. The article of claim 57, where the acyloxysilane has formula 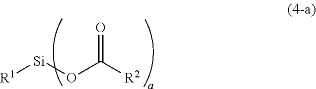
where subscript a has an average value greater than 2,
each R¹ is independently a monovalent hydrocarbon group, and
each R² is independently a hydrogen atom or an alkyl group of 1 to 4 carbon atoms.

61. (canceled)

62. The article of claim 57, where the substrate comprises paper, cardboard, boxboard, wood, wood products, wallboard, textiles, starches, cotton or wool.

63.-65. (canceled)
